(19) United States
(12) Patent Application Publication
(10) Pub. No.: US 2026/0311012 A1
(43) Pub. Date: Oct. 8, 2026

(54) APPLYING REINFORCEMENT LEARNING WITH NOISE EMULATION TO QUANTUM STATE PREPARATION

(71) Applicant: Dell Products L.P., Round Rock, TX (US)

(72) Inventors: Miguel Paredes Quiñones, Campinas (BR); Ítalo Gomes Santana, Rio de Janeiro (BR); Diego Vrague Noble, Pelotas (BR)

(21) Appl. No.: 19/098,845

(22) Filed: Apr. 2, 2025

(51) Int. Cl. G06N 10/20; G06N 20/00

(52) U.S. Cl. CPC G06N 10/20; G06N 20/00

(57) ABSTRACT

Reinforcement learning with noise emulation to prepare quantum states is disclosed. Using a dataset of random states, a model is trained to generate a preliminary circuit. A state preparation circuit, which is an inverse of the preliminary circuit can be used to place a quantum computing system in a desired initial state. Quantum jobs can be executed after the initial state is prepared.

### TECHNOLOGICAL FIELD OF THE DISCLOSURE

Embodiments disclosed herein generally relate to quantum computing and quantum state preparation. More particularly, at least some embodiments relate to systems, hardware, software, computer-readable media, and methods for preparing an initial quantum state using reinforcement learning with noise emulation.

### BACKGROUND

Quantum computing units (QPUs) or systems include real QPUs (real quantum hardware) and emulated QPUs (QPUs emulated/simulated in classical computing systems). QPUs include gate based QPUs and quantum annealers. When preparing to perform a quantum operation in a QPU, one of the requirements is to prepare a quantum state. Stated differently, the QPU is placed in an initial quantum state. While it may be relatively straightforward to place a QPU in a ground state, preparing a QPU to a particular state is much more difficult. The complexity increases exponentially as the number of qubits increases.

When attempting to prepare a particular state, it may be necessary to add a series of quantum operations (e.g., gates) that increase the circuit depth. Increasing the circuit depth increases the likelihood of introducing errors and noise. Consequently, preparing a QPU to a particular state is a challenging task that may include multiple attempts to mitigate the addition of errors and noise.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of an orchestration system configured to place a quantum computing system into an initial or desired state prior to executing a quantum job;

FIG. 2 discloses aspects of training a model configured to generate a preliminary circuit;

FIG. 3 discloses aspects of training a model to generate a preliminary circuit and aspects of generating a state preparation circuit from the preliminary circuit and aspects of applying the state preparation circuit in preparation for executing a quantum job; and

FIG. 4 discloses aspects of a computing device, a computing system, or a computing entity.

### DETAILED DESCRIPTION OF SOME EXAMPLE EMBODIMENTS

Embodiments disclosed herein generally relate to quantum computing and to preparing quantum states. More particularly, at least some embodiments relate to systems, hardware, software, computer-readable media, and methods for reinforcement learning based quantum state preparation.

Embodiments of the invention are discussed in the context of quantum computing units or quantum computing systems that may require the preparation of an initial state. There are a variety of reasons for preparing the initial state. For example, a quantum system evolves over time based on its initial state. Because qubits can exist in a superposition, the initial state defines the probabilities of these superpositions. For example, a qubit's state can be described as

$$\vert ψ 〉 = α \vert 0 〉 + β \vert 1 〉 .$$

In this example, the coefficients α and β are complex numbers. Further, the probabilities of measuring the qubit in states |0 [symbol] and |1 [symbol] are given by the squared magnitudes of the coefficients. Embodiments of the invention relate to preparing the quantum state of a quantum computing system.

Quantum state preparation is a process in quantum computing that initializes a quantum system into a specific quantum state, typically the ground state. There are multiple ways to prepare a state in embodiments of the invention, which can be classified in the following types, by way of example:
Exact State Preparation: This involves preparing a quantum state exactly as specified, often requiring complex circuits and a significant number of ancillary qubits;
Approximate State Preparation: This method aims to prepare a state that is close to the desired state, which can be implemented with a smaller circuit or ancillary qubits; and
Variational Methods/AI: These use optimization techniques to iteratively improve the quantum state towards the desired state.

Embodiments of the invention more specifically relate to methods that approximate quantum state preparation using reinforcement learning that resembles the noise added by adding a quantum gate on a circuit. Embodiments of the invention relate to generating a circuit that prepares a given state, which may be represented as a state vector.

More specifically, constructing a quantum circuit to prepare a desired state can be an expensive classical task that may act as a bottleneck in the context of executing quantum circuits or algorithms. Final circuits outputted from heuristics that perform state preparation can be large and noisy at least because heuristics do not guarantee optimality.

Embodiments of the invention address these and other issues. Embodiments of the invention relate to methods for preparing an arbitrary quantum state |s [symbol] using Reinforcement Learning (RL). Reinforcement Learning is often employed in problems that require sequential decisions, such as the sequential insertion of quantum gates in a quantum circuit. The insertion of gates can be understood as actions that can be applied in a quantum circuit by an agent capable of performing reinforcement learning.

In one example, each action is restricted to inserting a gate from a set of gates G associated with quantum hardware that will implement the logical quantum circuit. If a gate g present in the logical circuit is not included in the set of gates, the agent may employ a sequence of gates from the set of gates that is equivalent to g. These equivalences will exist once any hardware design implements basis gates that can compose any other gate.

In one example, embodiments of the invention output an Instruction Set Architecture circuit (ISA). Embodiments of the invention are discussed in the context of initializing a quantum computing system to an initial state |s [symbol] using a gate set G from hardware H. More generally, embodiments of the invention relate to generating a state preparation circuit that will place a quantum computing system in a desired initial state or approximately in the desired initial state.

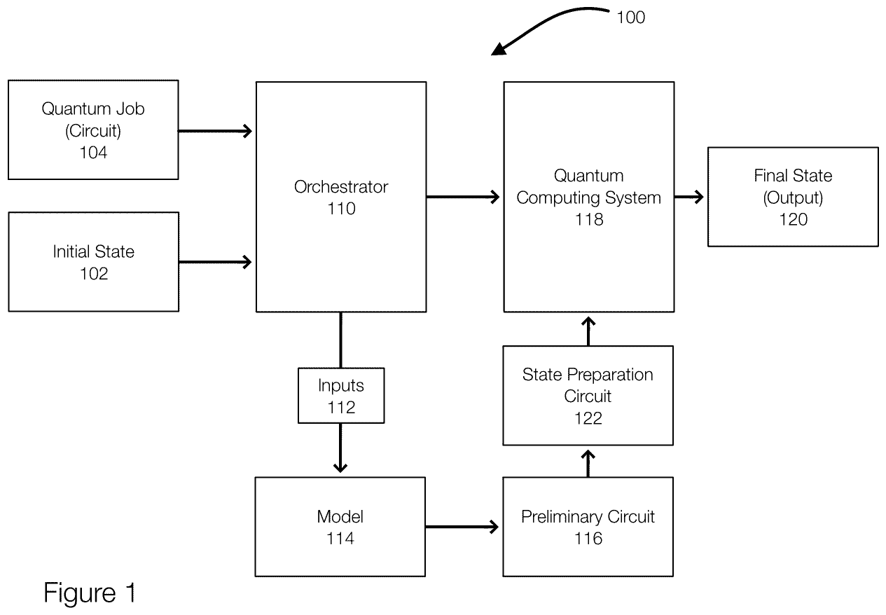

FIG. 1 discloses aspects of an orchestration system configured to place a quantum computing system in an initial state. More specifically, the orchestration system 100 may be configured to perform aspects or operations related to executing quantum circuits. These operations may be managed, controlled, and/or performed by an orchestrator 110 and may include, by way of example only, transpilation operations, circuit cutting operations, knitting operations, allocation operations, initialization operations, and the like. The orchestrator 110 may be implemented in classical computing (processors, memory) and have access to resources in including classical computing resources and quantum computing resources. The quantum computing resources may include real quantum computing systems and simulated or emulated quantum computing systems.

In this example, the orchestrator 110 may receive a quantum job 104 for execution. The orchestrator 110 may also receive an initial state 102. In this example, the orchestrator 110 is configured to place a quantum computing system 118 in the initial state 102. This is performed using a model 114, which is configured to generate a preliminary circuit 116, which is converted to a state preparation circuit 122. Executing the state preparation circuit 122 in the quantum computing system 118 places the quantum computing system 118 in the initial state 102 and the quantum job (circuit) 104 may then be executed in the quantum computing system 118 to generate a final state or output 120 for the quantum job 104.

In this example, the orchestrator 110 may provide inputs 112 to the model 114. The inputs 112 may include gates available to the quantum computing system 118, the initial state 102 and/or a current state of the quantum computing system 118. In one example, the current state of the quantum computing system 118 is |0 [symbol] . In another example, the state preparation circuit 122 is generated on as assumption that the current state of the quantum computing system 118 (e.g., before applying the state preparation circuit 118) is |0 [symbol] .

The model 114 may employ a reinforcement learning model that has been trained to generate a preliminary circuit 116. The state preparation circuit 122 is the inverse of the preliminary circuit 116 and is configured to place the quantum computing system 118 the initial state 102.

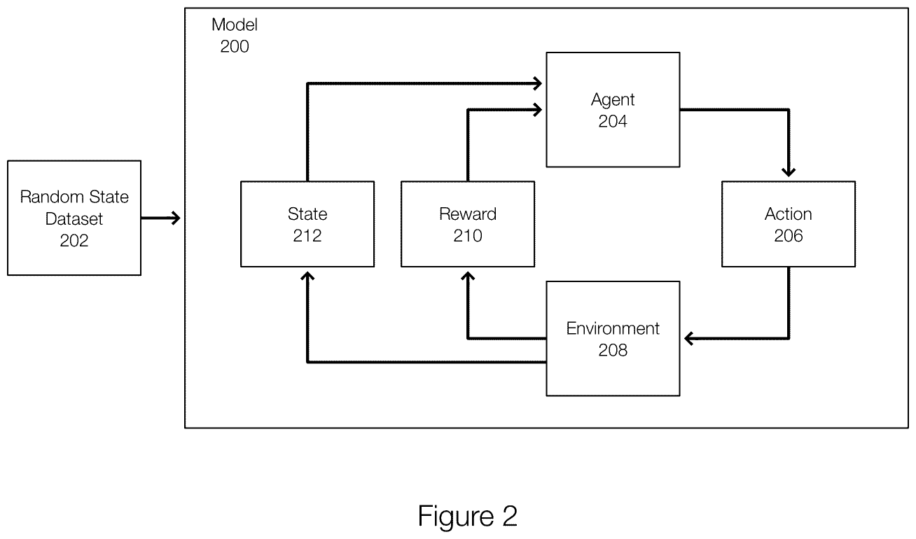

FIG. 2 discloses aspects of systems and methods for training a model to generate a preliminary circuit, which may be used to place a quantum computing system in an initial state prior to quantum circuit execution. In one example, a dataset 202 of random states may be generated or created for training the model 200. For example, the dataset 202 may be created by generating a random vector that represents a discrete probability distribution. This can be performed by sampling n random numbers (aⱼ) progressively on an interval between 0 and the sum of the previous probabilities, such that the random numbers sum to one (1). Next, n angles (0ⱼ) are sampled where n is the number of states (2^{N}), and N is the number of qubits. Using the n random numbers and the n angles, an initial vector may be created for a random state |sᵢ [symbol] of n complex numbers as follows:

$$\vert {s}_{i} 〉 = ( \begin{matrix}{a}_{1} ( cos ( {θ}_{1} ) + i sin ( {θ}_{1} ) ) \\ ⋮ \\ {a}_{n} ( cos ( {θ}_{n} ) + i sin ( {θ}_{n} ) )\end{matrix} ) .$$

The random state dataset 202 is used to train the model 200. In one example, an agent 204 may apply gates in a set of gates (G) to the random state in an attempt to convert or change the random state to a state |0 [symbol] _{N}. In one example, reinforcement learning is performed by adding gates that change the random state |sᵢ [symbol] to the ground state |0 [symbol] _{N}.

Once the gates have been identified, which are an example of a preliminary circuit, the inverse circuit may be used to prepare the state |sᵢ [symbol] starting from the ground state |0 [symbol] _{N}. In one example, the inverse circuit (or state preparation circuit) is obtained by applying the gates added by the agent 204 in an inverse order. An inverse circuit applied to the original circuit results in the original initial state because this process is equivalent to applying an identity.

Thus, the action 206 performed by the agent 204 is to apply a gate selected from the set of gates G. Placing the gate in the environment 208 (e.g., a circuit) will result in a new current state 212 and a reward 210. This process is repeated until the model 200 is trained.

With regard to the reward function used to determine the reward 210, the reward 210 is proportional to a fidelity function between a current state and the ground state |0 [symbol] _{N} and may be performed as follows:

$${r}_{t} = {2}^{〈 {0}_{N} \vert {s}_{t} 〉} .$$

In one example, an exponential function is applied to the fidelity because it may be beneficial to reward higher fidelities compared to employing a linear relationship. In this example, rₜ is a partial reward function. If the fidelity function cannot be calculated, the fidelity function can be obtained empirically by using a proxy for the fidelity. An example of a proxy for the fidelity function is to sample the current circuit in real hardware a number of times and use a proportion of zero states obtained in the total number of samplings.

In one example, a progressive discount may be employed and may depend on a number of steps of the current state, which is equivalent to a depth of the current circuit being generated:

$${R}_{t} = {f}_{1} \times … \times {f}_{t} \times {r}_{t} .$$

A progressive discount allows noise added to the circuit by the addition of gates to be emulated at every time step t. In one example, f is the fidelity of a quantum gate. In one example, two-qubit gates may produce lower rewards and, in turn, rewards solutions that use fewer gates. Embodiments may assume that identity gates do not have errors. The reinforcement learning illustrated for the model 200 in FIG. 2 can continue, in one example, until a circuit is discovered that prepares a state |s [symbol] . In one example, the trained reinforcement model 200 is trained to discover or create a circuit that results in a fidelity of [symbol] 0_{N}|s_{T} [symbol] ≈1.

Once this circuit is created with a sufficient fidelity (e.g., within a threshold amount), a quantum circuit may be created with an inverse order of gates to prepare a state |s [symbol] .

In a practical embodiment, once qubits are started at zero, resolving this quantum state |s [symbol] provides a desired state for the remaining quantum circuit for which an initial state is prepared.

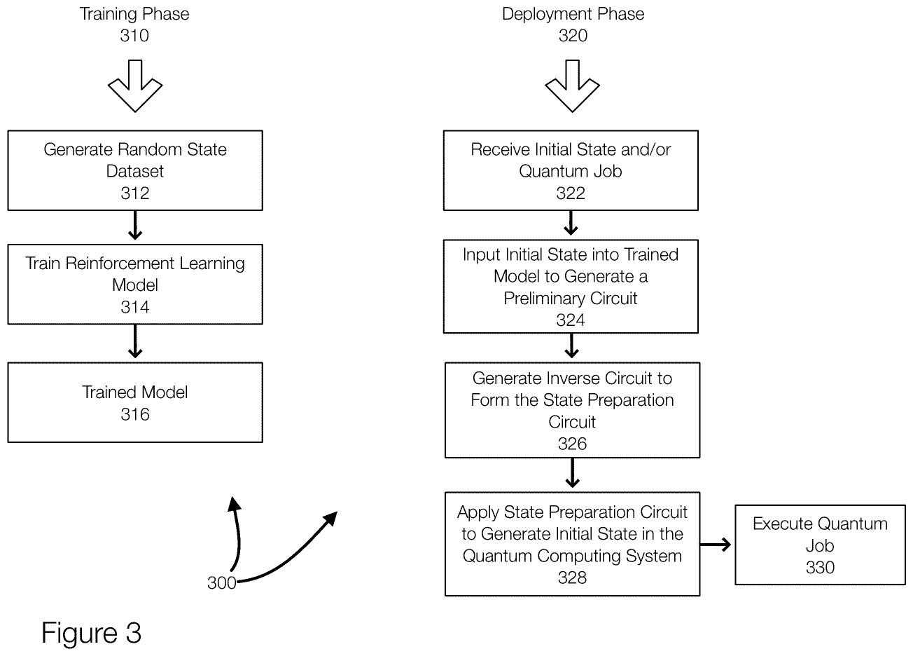

FIG. 3 discloses aspects of a method for preparing a state preparation circuit. The method 300 may include a training phase 310 and a deployment phase 320. These phases 310 and 320 may be performed separately. In the training phase 310, a dataset of random states 312 is generated. In some examples, the dataset relate to a particular number of qubits.

Next, reinforcement learning is performed 314 to train a model. The model is trained, in one example, to generate a preliminary circuit that changes the random state obtained from the dataset to a ground state (or other desired state). In one example, the output of the trained model 316 is a circuit that generates a state in a quantum computing system having high fidelity to the ground state such as:

$$〈 {0}_{N} \vert {s}_{T} 〉 \approx 1.$$

Once the model is trained to generate the preliminary circuit, the model may be deployed and the deployment phase 320 may be performed. In the deployment phase 320, an orchestrator may receive 322 an initial state and/or a quantum job. In one example, a client may desire to perform a quantum job that starts from the initial state. Thus, the orchestrator is tasked with preparing the quantum computing system to have the desired initial state.

The initial state is input 324 into the trained model 316 to generate the preliminary circuit that is relevant to the quantum job received from a client. Next, an inverse of the preliminary circuit is performed to generate 326 the state preparation circuit. In one example, the quantum computing system to be used to execute the quantum job may be initialized to a ground state |0 [symbol] _{N}. Applying 328 the state preparation circuit to the quantum computing system places the quantum computing system in the initial state. The quantum job is then executed 330, starting from the initial state achieved by applying or performing the state preparation circuit to generate a final state or result.

Embodiments of the invention employ a reinforcement learning process to construct a circuit for a state preparation operation. Embodiments of the invention further account for gate fidelity when training the reinforcement learning model as a reward. Embodiments of the invention further relate to systems that methods that do not require quantum devices or quantum simulations to train machine learning models for quantum state preparation.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, quantum state preparation operations, quantum circuit generation operations, inverse quantum circuit operations, machine learning training/inference operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide functionality for one or more clients. Another example of a cloud computing environment is one in which processing, quantum circuit execution, data protection, and other, services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.
Embodiment 1. A method comprising: generating a dataset of random states for training a reinforcement learning model, training the reinforcement learning model by applying gates selected from a set of gates to create a preliminary circuit for an input state until a fidelity associated with the preliminary circuit and a state |0 [symbol] _{N} is within a threshold of one, and generating a state preparation circuit from the preliminary circuit, wherein the state preparation circuit is an inverse of the preliminary circuit, wherein applying the state preparation circuit to a quantum computing system places the quantum computing system in the input state.
Embodiment 2. The method of embodiment 1, wherein generating the dataset of random states includes: generating a discrete probability distribution by sampling n random numbers progressively on an interval between 0 and a sum of previous probabilities such that the n random numbers sum to 1, the discrete probability distribution comprising sampling n angles, wherein n is a number of states 2^{N} and N is a number of qubits.
Embodiment 3. The method of embodiment 1 and/or 2, wherein an initial vector for |sᵢ [symbol] of n complex numbers includes:

$$\vert {s}_{i} 〉 = ( \begin{matrix}{a}_{1} ( cos ( {θ}_{1} ) + i sin ( {θ}_{1} ) ) \\ ⋮ \\ {a}_{n} ( cos ( {θ}_{n} ) + i sin ( {θ}_{n} ) )\end{matrix} ) .$$

Embodiment 4. The method of embodiment 1, 2, and/or 3, wherein the reinforcement learning model determines a reward for an action that is proportional to a fidelity function between a current state and a state |0 [symbol] _{N}.
Embodiment 5. The method of embodiment 1, 2, 3, and/or 4, wherein the partial reward function is an exponential function.
Embodiment 6. The method of embodiment 1, 2, 3, 4, and/or 5, wherein the partial reward function is a linear function.
Embodiment 7. The method of embodiment 1, 2, 3, 4, 5, and/or 6, wherein the fidelity function is determined empirically.
Embodiment 8. The method of embodiment 1, 2, 3, 4, 5, 6, and/or 7, further comprising applying a progressive discount that depends on a depth of a current preliminary circuit.
Embodiment 9. A method comprising: receiving a quantum job and an initial state at an orchestrator, inputting the initial state into a trained model configured to output a preliminary circuit having a fidelity with respect to a state |0 [symbol] _{N} that is within a threshold of one, generating a state preparation circuit from the preliminary circuit, wherein the state preparation circuit is an inverse of the preliminary circuit, applying the state preparation circuit to a quantum computing system to place the quantum computing system in the initial state, and performing the quantum job in the quantum computing system.
Embodiment 10. The method of embodiment 9, further comprising training the trained model with a dataset of random states, wherein the trained model is trained by adding gates to the preliminary circuit until the fidelity is achieved.
Embodiment 11. The method of embodiment 9 and/or 10, wherein the gates are selected from a set of gates of the quantum computing system.
Embodiment 12. The method of embodiment 9, 10, and/or 11, wherein a gate not included in the set of gates is replaced with an equivalent string of gates selected from the set of gates.
Embodiment 13. A system, comprising hardware and/or software, operable to perform any of the operations, methods, or processes, or any portion of any of these, disclosed herein.
Embodiment 14. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

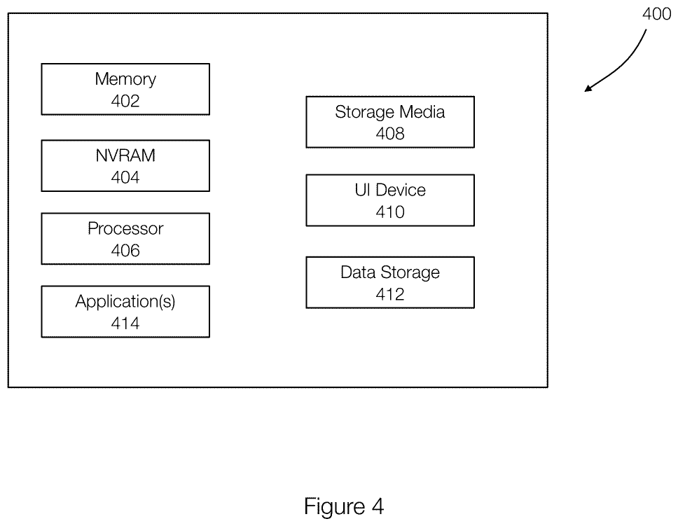

With reference briefly now to FIG. 4, any one or more of the entities disclosed, or implied, by the Figures, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may be configured to perform orchestration operations, simulated or emulated quantum related operations, state preparation operations, or the like. The device 400 may also be used in aspects of orchestrating the execution of a problem, which may include placing a quantum computing system in an initials state.

The described embodiments are to be considered in all respects only as illustrative and not restrictive. All changes which come within the meaning and range of equivalency of the claims are to be embraced within their scope.

What is claimed is:

1. A method comprising:
generating a dataset of random states for training a reinforcement learning model;
training the reinforcement learning model by applying gates selected from a set of gates to create a preliminary circuit for an input state until a fidelity associated with the preliminary circuit and a state |0 [symbol] _{N} is within a threshold of one; and
generating a state preparation circuit from the preliminary circuit, wherein the state preparation circuit is an inverse of the preliminary circuit,
wherein applying the state preparation circuit to a quantum computing system places the quantum computing system in the input state.

2. The method of claim 1, wherein generating the dataset of random states includes:
generating a discrete probability distribution by sampling n random numbers progressively on an interval between 0 and a sum of previous probabilities such that the n random numbers sum to 1;
the discrete probability distribution comprising sampling n angles,
wherein n is a number of states 2^{N} and N is a number of qubits.

3. The method of claim 2, wherein an initial vector for |sᵢ [symbol] of n complex numbers includes:
$$\vert {s}_{i} 〉 = ( \begin{matrix}{a}_{1} ( cos ( {θ}_{1} ) + i sin ( {θ}_{1} ) ) \\ ⋮ \\ {a}_{n} ( cos ( {θ}_{n} ) + i sin ( {θ}_{n} ) )\end{matrix} ) .$$

4. The method of claim 1, wherein the reinforcement learning model determines a reward for an action that is proportional to a fidelity function between a current state and a state |0 [symbol] _{N}.

5. The method of claim 4, wherein the partial reward function is an exponential function.

6. The method of claim 4, wherein the partial reward function is a linear function.

7. The method of claim 4, wherein the fidelity function is determined empirically.

8. The method of claim 4, further comprising applying a progressive discount that depends on a depth of a current preliminary circuit.

9. A non-transitory storage medium having stored therein instructions that are executable by one or more hardware processors to perform operations comprising:
generating a dataset of random states for training a reinforcement learning model;
training the reinforcement learning model by applying gates selected from a set of gates to create a preliminary circuit for an input state until a fidelity associated with the preliminary circuit and a state |0 [symbol] _{N} is within a threshold of one; and
generating a state preparation circuit from the preliminary circuit, wherein the state preparation circuit is an inverse of the preliminary circuit,
wherein applying the state preparation circuit to a quantum computing system places the quantum computing system in the input state.

10. The non-transitory storage medium of claim 9, wherein generating the dataset of random states includes:
generating a discrete probability distribution by sampling n random numbers progressively on an interval between 0 and a sum of previous probabilities such that the n random numbers sum to 1;
the discrete probability distribution comprising sampling n angles,
wherein n is a number of states 2^{N} and N is a number of qubits.

11. The non-transitory storage medium of claim 10, wherein an initial vector for |sᵢ [symbol] of n complex numbers includes:
$$\vert {s}_{i} 〉 = ( \begin{matrix}{a}_{1} ( cos ( {θ}_{1} ) + i sin ( {θ}_{1} ) ) \\ ⋮ \\ {a}_{n} ( cos ( {θ}_{n} ) + i sin ( {θ}_{n} ) )\end{matrix} ) .$$

12. The non-transitory storage medium of claim 9, wherein the reinforcement learning model determines a reward for an action that is proportional to a fidelity function between a current state and a state |0 [symbol] _{N}.

13. The non-transitory storage medium of claim 12, wherein the partial reward function is an exponential function.

14. The non-transitory storage medium of claim 12, wherein the partial reward function is a linear function.

15. The method of claim 4, wherein the fidelity function is determined empirically.

16. The non-transitory storage medium of claim 12, further comprising applying a progressive discount that depends on a depth of a current preliminary circuit.

17. A method comprising:
receiving a quantum job and an initial state at an orchestrator;
inputting the initial state into a trained model configured to output a preliminary circuit having a fidelity with respect to a state |0 [symbol] _{N} that is within a threshold of one;
generating a state preparation circuit from the preliminary circuit, wherein the state preparation circuit is an inverse of the preliminary circuit;
applying the state preparation circuit to a quantum computing system to place the quantum computing system in the initial state; and
performing the quantum job in the quantum computing system.

18. The method of claim 17, further comprising training the trained model with a dataset of random states, wherein the trained model is trained by adding gates to the preliminary circuit until the fidelity is achieved.

19. The method of claim 18, wherein the gates are selected from a set of gates of the quantum computing system.

20. The method of claim 19, wherein a gate not included in the set of gates is replaced with an equivalent string of gates selected from the set of gates.
